(19) United States
(12) Patent Application Publication
(10) Pub. No.: US 2014/0267960 A1
(43) Pub. Date: Sep. 18, 2014

(54) Modified Viewable Display Apparatus

(71) Applicant: TEKAMAKI VENTURES, San Carlos, CA (US)

(72) Inventor: Matthew E. Ward, Philadelphia, PA (US)

(73) Assignee: TEKAMAKI VENTURES, San Carlos, CA (US)

(21) Appl. No.: 14/208,717

(22) Filed: Mar. 13, 2014

Related U.S. Application Data
(60) Provisional application No. 61/779,370, filed on Mar. 13, 2013.

(51) Int. Cl. G02B 27/26; G02F 1/1335

(52) U.S. Cl. CPC G02B 27/26; G02F 1/133528
USPC 349/15; 349/96

(57) ABSTRACT

A method of display manufacturing/modification exploits the characteristics of remotely-locating one of the polarizers required to view a video display.

### BACKGROUND

Polarizers present creative opportunities for displays that few people have tapped into. In fact, polarizers in displays have often been limited to applications like polarizing sheets that cover computer displays and ensure screen privacy. Such screens have a limited viewing angle that blocks viewers from seeing the screen unless they are looking at the screen relatively straight-on. Further, most polarizers are cut to the utilitarian shape that reflects their use: rectangular for viewing screens or custom shapes for glasses. These utilitarian-shaped polarizers and privacy screens do not provide much of a creative medium for designers.

In the retail display field, transparent displays allow for screens to project images onto a display surface where objects behind the display remain visible. Transparent display technology allows retailers to overlay images and information in front of actual products or other tangible objects. This type of multimedia presentation—displays that interact with an actual object—opens creative possibilities for both retailers and designers.

### SUMMARY

Both polarizers and transparent displays, alone or in combination, present creative opportunities described herein.

A display comprises a light source; a rear polarizer; a liquid crystal; and a front polarizer; wherein the light source, rear polarizer, and the liquid crystal are contained within an integral unit and the front polarizer is removed from the integral unit at a distance.

The remote polarizer expands traditional display technology. By limiting visibility to specific places or points, an entire new set of design capabilities is possible.

### BRIEF DESCRIPTION OF THE DRAWINGS

FIG. 1 shows a schematic of an LCD optical stack.

FIG. 2 shows a standard LCD display.

FIG. 3 shows the display of FIG. 2 with the front polarizer removed at a distance.

FIG. 4 shows two variations of a front polarizer.

FIG. 5 shows a transparent LCD with a remote polarizer.

FIG. 6 shows a transparent LCD with a remote polarizer with an inverted pattern cutout.

FIGS. 7A and 7B show a modified front polarizer in use with a transparent LCD.

FIGS. 8A and 8B show a inverted pattern polarizer in use with a transparent LCD.

FIG. 9 shows a modified polarized set off at a distance from a display.

FIGS. 10 and 11 show a modified polarizer set off at a distance from a display, where the polarizer is mounted in an object.

FIG. 12 shows another embodiment of the remote display.

FIG. 13 shows another embodiment of the display.

FIG. 14 shows a schematic of another embodiment of the display.

### DETAILED DESCRIPTION OF THE PREFERRED EMBODIMENTS

Polarizer System

Liquid Crystal Display (LCD) displays comprise a system that integrates layers of materials to achieve specific visual effects when viewed from certain angles. Such a system can be a part of LCD technology, and may be comprised of primary and secondary polarizing films that provide different visual effects.

A simplified LCD system may comprise an LCD component that is sandwiched between two polarizing films. When all the layers are used, the pixel elements of the LCD may be viewable and with only one polarizing film in the stack, the pixel elements of the LCD may not be viewable.

FIG. 1 illustrates a schematic structure of an LCD optical stack. While differences exist between manufacturers, this structure shows a common layering. A backlight unit light source 101 provides unpolarized white light that passes through a rear polarizer 102, a liquid crystal 103, a color filter 104, and a front polarizer 105 with the light traveling in a direction 106 towards a user.

The two polarizing filters 102, 105 may have axes of light transmission perpendicular to each other. Without the liquid crystal 103 between the polarizing filters 102, 105, light passing through the first polarizer 102 would be blocked by the second polarizer 105. The manipulation of the light by the liquid crystal makes for a visual image on a screen. FIG. 2 shows a display 201 projecting such a visual image 202.

Remote-Locating a Polarizer, Shaping a Polarizer

A front polarizer may be offset from a display by interposing the front polarizer sheet in between the viewer's line of sight and the display. This has been done with polarized glasses as a security feature on certain laptops that allow someone with the glasses to view an image invisible to a person without the glasses.

When mass-manufactured, most displays have a front polarizer directly incorporated into the display, but this design is not mandatory: The display's body may be physically disconnected from its front polarizer, which opens many creative opportunities for designers. Further, the shape of such polarizers need not be limited to the shape of the screen or eye-covering—the polarizer shape can be anything.

This system may require both the display and polarizer to function correctly—without one, the other may not function.

FIG. 3 shows a removed front polarizer 305 at a distance from an integral display unit 202 that contains the layers of the LCD display 201 except for the polarizer 305. Removing the front polarizer 305 at a distance from the integral display unit 202 allows for an optical sensor 330 (a person or camera) to view an image on the integral unit 202 using the polarizer 305 almost like a portal. This offset polarizer 305 offers certain creative possibilities, the examples of which follow. In manufactured sale of the displays 201 following the designs proposed herein, an LCD display 201 could be manufactured without the front polarizer 305 or with a detachable front polarizer 305.

FIG. 4 shows two variations of a polarizer film or layer 405 cut into a snowflake shape 401. The desired shape may be the snowflake 401 or its inverse shape 402 and either or both of the shape 401 or its inverse 402 may be used with a display 201 to function as the front polarizer.

Thus, the polarizer's shape need not be limited to the display shape or the shape of an eyeglass lens. Remote polarizers may be of any shape and size and integrated onto secondary structures such as store windows, beverage cases, motor vehicle windows, home and building windows. Such a polarizer could be cut into the shape of a popular soft drink bottle, snowflake, or others. This apparatus may be a two-part system comprised of a functional non-viewable display comprised of one half of its optical polarizing system and a secondary system of remote-positioned polarizing films.

Remote Polarizer or Modified Polarizer on Transparent Displays

A display without one of the polarizing films is perceived simply as a light source and a transparent display, which inherently lacks an integrated backlight and mechanical housing that blocks the surface area of the display, is simply seen as a clear (or colored translucent) material.

In combination with a polarizer, either integral to the transparent display or remote from it, the use of a transparent display and polarizer allows for further creative opportunities described herein.

Transparent displays and in particular transparent LCDs are a newcomer to display technology. Samsung and others started to produce them as of 2012-2013. Transparent LCD displays provide many creative avenues for designers. Imagine a shop window displaying an actual shirt, but the transparent display in front of the shirt depicting the shirt colors or models showing off the shirt. Or picture a display mounted above an actual shirt that is fed by a camera, allowing someone to see their head/body “in” the shirt. These are just some of the ways that transparent LCD panels might be used.

FIGS. 5 and 6 illustrate a transparent LCD display wall structure 500 comprised of multiple transparent LCD panels 501. Such a wall structure allows for larger transparent LCD wall 500 than may be possible with current technologies. It should be appreciated that the bezels 503 limit the wall structure 500's open appearance and thus minimizing the bezel size or placing them in a way to minimize their impact contributes to an improved wall structure 500.

As shown in FIGS. 5 and 6, the front polarizer may be a shaped polarizer 401, variations comprised of multiple shaped parts across multiple panels 502, or inverse shapes 402.

FIGS. 7A and 7B illustrate the visual effect of using a removed and shaped polarizing film 401 with a transparent LCD display 701. With the snowflake-shaped polarizer 401 in place, images projected through the LCD display 701 may be visible within the shaped polarizer 401 while the remaining surface of the transparent LCD will remain transparent and the object 710 behind the screen will be visible. While what is shown here is a snowflake-shaped front polarizer 401 and snowman 710, more creative applications of this technology are possible.

FIGS. 8A and 8B show a similar arrangement to FIGS. 7A and 7B but FIGS. 8A and 8B show an inverted pattern polarizer 402 in use with a transparent LCD 801. In such an application as shown in FIGS. 8A and 8B, the object 710 is visible through the snowflake cutout instead of around it. As shown in FIGS. 8A and 8B, the snowflake cutout area remains transparent while the remaining portion of the inverted-pattern polarizer 402 can be used to project images.

FIG. 9 illustrates an application of a transparent display 901 lacking an integral front polarizer in which the modified front polarizer 401 is located at a distance from the liquid crystal 103 and display 901. As shown, the front polarizer 401 is mounted on a secondary surface 920 at an offset distance from the display 901. This allows for viewing of the object 710 behind the display 901 from viewing angles to the sides of the polarizer 401. But when viewed through the shaped polarizer 401, a viewer 930 would see images generated from the display 901. Thus, the shaped polarizer 401 functions as a portal to see the displayed images not visible to viewers not looking through the polarizer 401. This same effect is possible with the inverted-pattern polarizer 402.

FIGS. 10 and 11 show another variation where a front polarizer 1010 has been removed from a display 1000. For the sake of simplicity, the polarizer 1010 (in the form to be described) replaces the polarizer 401 and secondary surface 920 in FIG. 9. As shown in FIG. 10, the polarizer 1010 is embedded within a secondary object 1020, in this case a crystal ball held by a wizard 1022. To improve on the aesthetic of the polarizer 1010 in this setting, the polarizer 1010 is embedded within two halves 1021 of the crystal ball 1020. Looking into the crystal ball 1020 and the polarizer 1010 therein, a person 1030 might see different images 1001 if the polarizer 1010 was aligned between the viewer's eye 1030 and a display 1000. This could provide for a unique and realistic crystal ball effect. If viewing angles were managed properly it is possible that only one half 1021 of the crystal ball 1020 might be required. Further, of course, the displays 1000 could be transparent or opaque.

FIG. 12 illustrates the use of the system disclosed where a consumer electronics device sits on a exclamation point 1220. The exclamation point 1220 sits in front a display 1200 that has had the front polarizer 1210 removed. The display 1200 is fed an image 1201 that the user desires to see through the polarizer 1210.

FIG. 13 shows how a transparent display 1300 with or without a set-off front polarizer 1301, could be retrofit to an existing beverage case 1380 or similar clear case. In such a display 1300, a polarizer 1301 might be used to display advertising or other brand messages, while still allowing a viewer to see items 1310 in the case. Power and mechanical attachment could be made to the display 1300 through mounts 1315 with cables therein or other means.

The entire front panel 1370 of the beverage case 1380 could also be a display 1300, with or without a polarizer, but until the prices of such panels decrease, the above retrofitted panel solution may be preferable.

Display Using Screen with Portions Removed

FIG. 14 shows an alternate display arrangement. In it, a lenticular screen material 1450 that is auto stereoscopic (also called AS3D) is interspersed with display areas without the auto stereoscopic material 1460.

The auto stereoscopic material 1450 may receive multiple slices of a video and project different slices to different eyes, which allows for 3D image creation that can be viewed without glasses. Such a display with interspersed auto stereoscopic material 1450 and gaps 1460 to form patterns could be used with a transparent display. The combination of 3D images possible in the auto stereoscopic material 1450 and real objects visible through the gaps 1460 opens many creative possibilities.

Such a display might be comprised of layers that are:

X % AS3D

Y % standard transparent LCD

Z % transparent LCD without the front polarizer.

This gives a designer at least three different layers to manipulate visual effects.

The method and apparatus herein are not dependent on any specific manufacturer and can be used with a wide variety of display technology.

I claim:

1. A display comprising:
a light source;
a rear polarizer;
a liquid crystal; and
a front polarizer;
wherein the light source, rear polarizer, and the liquid crystal are contained within an integral unit and the front polarizer is removed from the integral unit at a distance.

2. The display of claim 1, wherein when the front polarizer is aligned between the integral unit and an optical sensor, an image is visible to the optical sensor.

3. The display of claim 2, wherein when the front polarizer is not aligned between the integral unit and the optical sensor, the image is not visible to the optical sensor.

4. The display of claim 1, wherein the front polarizer is mounted on a secondary surface.

5. The display of claim 1, wherein the rear polarizer, and liquid crystal present a transparent appearance.

6. The display of claim 1, wherein the front polarizer is shaped differently than the integral unit.

7. The display of claim 1, further comprising an auto stereoscopic material.

8. The display of claim 7, wherein the auto stereoscopic material is interspersed between gaps in the auto stereoscopic material.

9. A display comprising:
a light source;
a rear polarizer;
a liquid crystal; and
a front polarizer;
wherein the light source, rear polarizer, and the liquid crystal are contained within an integral unit and; and
wherein the front polarizer has a smaller surface area than the integral unit.

10. The display of claim 9, wherein the front polarizer is removed from the integral unit at a distance.

11. The display of claim 10, wherein when the front polarizer is aligned between the integral unit and an optical sensor, an image is visible to the optical sensor.

12. The display of claim 11, wherein when the front polarizer is not aligned between the integral unit and the optical sensor, the image is not visible to the optical sensor.

13. The display of claim 9, wherein the front polarizer is mounted on a secondary surface.

14. The display of claim 9, wherein the front polarizer is mounted within an object.

15. The display of claim 9, wherein the display includes mounts for attaching the display.

16. The display of claim 9, further comprising an auto stereoscopic material.

17. The display of claim 16, wherein the auto stereoscopic material is interspersed between gaps in the auto stereoscopic material.

18. The display of claim 9, further comprising multiple displays.
